(19) United States
(12) Patent Application Publication
(10) Pub. No.: US 2006/0045327 A1
(43) Pub. Date: Mar. 2, 2006

(54) Optical turret and method of use

(75) Inventors: Thanh Dang, San Jose, CA (US); Hai Dau, San Ramon, CA (US); Vincent Michael DePalma, San Jose, CA (US); Robert Page, San Jose, CA (US)

Correspondence Address: PATRICK REILLY, BOX 7218, SANTA CRUZ, CA, 95061-7218, US

(73) Assignee: NEW WAVE RESEARCH, INC.

(21) Appl. No.: 11/202,672

(22) Filed: Aug. 12, 2005

Related U.S. Application Data
(60) Provisional application No. 60/602,023, filed on Aug. 16, 2004.

(51) Int. Cl. G06K 9/00

(52) U.S. Cl. 382/151

(57) ABSTRACT

A method and device for positioning a viewing objective and an alternate objective in relationship to a viewpoint and/or a light energy source are provided. A plurality of objective lenses are coupled with a carriage plate. The carriage plate moves along a single axis and positions the objective lenses for use in delivering a laser beam to an object and/or enabling observation of the object by a human operator. A version includes a linear turret or “optical turret” for positioning at least one objective relative to a light energy source, where the optical turret is communicatively coupled with a processor and the optical turret includes (1) at least one objective; (2) a carriage plate, (3) a linear rail, (4) a scale, (5) a sensor, and (6) a linear motor.

### FIELD OF THE INVENTION

The present invention relates to the field of optics. More particularly, the present invention relates to the positioning of objective lenses.

### BACKGROUND OF THE INVENTION

Optical devices are presently widely used in medicine, manufacturing, public safety and military applications to observe optically detectable features and/or processes, and to direct light energy, e.g. lasers. Improvements therefore in the capability of accurately and reliably positioning an objective lens (“objectives”) within certain automated or semi-automated systems and equipments can greatly increase the economic value of numerous investigative methods, systems, and equipment in a wide variety of industrial, scientific and academic applications. Furthermore, increases in speed, precision, and reliability of positioning an objective can greatly increase the effectiveness and value of many automatic and semi-automatic systems in various ranges of use. As one exemplary area, certain optical systems use light to first observe and then to modify or affect a specimen, product, or other object. In particular, many uses of light by optical systems require an operator or programmed system to both observe an object using ambient light via a first objective, and to apply light energy to the object by means of a second objective.

The prior art includes modules for positioning one or more objectives that include ball screws and/or rotary encoders. Objective positioning systems that use ball screws typically present limitations in the reliability and accuracy of the objective position due to (1) wearing of mechanical components of the module, (2) thermal expansions and contractions, (3) and fatigue caused by the weight of movable parts of the module. In addition, prior art ball screw designs often require an undesirable frequency of lubrications, which is especially burdensome and problematic in a clean room or other environments that attempt to reduce or eliminate the presence of contaminants, pollution, and/or infectious agents. Prior art objective positioning systems that use rotary encoders usually are limited in positioning accuracy by imprecision of their encoder feedback technique.

There is, therefore, a long felt need to provide an objective positioning system that provides increased reliability and accuracy in positioning one or more objectives. It is an object of the present invention to provide a system and method that enables the precise, repeatable and reliable positioning of an objective in relationship to an object

### SUMMARY OF THE INVENTION

Towards this and other objects that will be made obvious in light of the present disclosure, a system and method is provided to accurately position an objective. Certain preferred embodiments of the method of the present invention apply/and or provide an objective positioning element (“linear turret”) having a linear motor that positions a carriage plate holding at least one objective, whereby the carriage plate moves under magnetic force and reducing mechanical contact between the carriage plate and a linear rail or other element of the linear turret. Certain alternate preferred embodiments of the method of the present invention apply and/or provide a linear turret having a piezo-electric motor that positions the carriage plate holding at least one objective, whereby the carriage plate moves by means of mechanical force applied by fingers of the piezo-electric motor and against another component of the linear turret.

A first preferred embodiment of the present invention includes a linear turret or “optical turret” for positioning at least one objective relative to a light energy source, where the optical turret is communicatively coupled with a processor and the optical turret includes (1) at least one objective; (2) a carriage plate, (3) a linear rail, (4) a scale, (5) a sensor, and (6) a linear motor. The carriage plate may be configured with a first objective aperture coupled with one or more objectives. The linear rail substantively limits movement of the carriage plate along two orthogonal linear axes and enables linear movement of the carriage plate along a third linear axis. The scale may be coupled to the optical turret and the scale may have a plurality of linear distance indicators. The sensor is communicatively coupled with the processor and is mechanically coupled with the optical turret and detects at least one of the linear distance indicators. The linear motor adjustable positions the carriage plate. The linear motor is also communicatively coupled with and directed by the processor, and mechanically coupled with the carriage plate.

In various alternate preferred embodiments of the present invention the linear motor may be or comprise (a) a non contact linear motor, wherein the carriage plate is configured to move under the influence of the non contact linear motor; (b) a magnetic system wherein the carriage plate is configured to move under the influence of a magnetic force generated by the magnetic system; (c) piezo-electric fingers, wherein the piezo-electric fingers are mechanically coupled with the carriage plate, and the piezo-electric fingers are positioned to physically drive the carriage plate by transferring mechanical momentum to the carriage plate to move the carriage plate substantively along the third linear axis; (d) a ceramic motor; and/or (e) an ultrasonic ceramic linear motor.

In various other alternate preferred embodiments of the present invention the carriage plate may further be or comprise a cross roller bearing, where the cross roller bearing is positioned to facilitate movement of the carriage plate in contact with the linear rail. Certain other alternate preferred embodiments of the present invention may comprise a cross roller bearing, an air bearing and/or other suitable bearings known in the art that may be configured to employ a low vapor pressure lubricant.

In various yet alternate preferred embodiments of the present invention the sensor is coupled with the carriage plate and the scale is coupled with the linear rail, and/or the sensor may further comprise (1) a linear encoder that is communicatively coupled with the processor and the sensor, (2) an interferometer. Additionally or alternatively, the sensor and the linear encoder may be coupled with the carriage plate and the scale may be coupled with the linear rail.

In various additional alternate preferred embodiments of the present invention the optical turret may comprise a second objective aperture of the carriage plate, and a second objective, wherein the second objective is coupled with the second objective aperture, and the at least one objective and the second objective are simultaneously positioned along the third axis.

In various additional alternate preferred embodiments of the present invention the optical turret includes, or is communicatively coupled with, a processor, such as an Intel Pentium microprocessor, and the optical turret may comprise (a) at least one objective; (b) a means to substantively constrain movement of the at least one objective along two orthogonal axis, wherein linear movement substantively along a third axis is enabled; (c) a scale, the scale coupled with the optical turret, and the scale having a plurality of linear distance indicators located along the third axis; (d) a sensor, the sensor mechanically coupled with the optical turret and communicatively coupled with the processor, the sensor for detecting at least one of the linear distance indicators, and the sensor communicatively coupled with the processor; (e) and a linear motor, the linear motor for adjustable positioning of the carriage plate, where the linear motor is mechanically coupled with the carriage plate communicatively coupled with and directed by the processor.

In certain still additional alternate preferred embodiments of the present invention, the linear turret may have a linear motor wherein the linear motor is a magnetic system and the carriage plate is configured to move under the influence of a magnetic force generated by the magnetic system. Alternatively or additionally the optical turret may have a linear motor that has piezo-electric fingers, wherein the piezo-electric fingers are mechanically coupled with the carriage plate, and the piezo-electric fingers physically drive the carriage plate by transferring mechanical momentum to the carriage plate to move the carriage plate substantively along the third linear axis. Furthermore, the optical turret may additionally comprise a second objective coupled with a second objective aperture of the carriage plate whereby the at least one objective and the second objective are simultaneously positioned along the third axis.

Certain other preferred embodiments of the method of the present invention provide a method of positioning at least one objective relative to a light energy source, the method including (1) coupling the at least one objective to a carriage stage; (2) enabling movement of the carriage stage by a linear motor; (3) enabling control of the linear motor by a processor; (4) providing information to the processor describing the approximate position of the carriage relative to the light energy source; and (5) directing the processor to position the at least one objective to a specific approximate orientation of the at least one objective.

The foregoing and other objects, features and advantages will be apparent from the following description of the preferred embodiment of the invention as illustrated in the accompanying drawings.

### BRIEF DESCRIPTION OF THE DRAWINGS

These, and further features of the Present Invention, may be better understood with reference to the accompanying specification and drawings depicting the preferred embodiment, in which:

FIG. 1 is a perspective view of a prior art optical turret;

FIG. 2 is a top view of a first preferred embodiment of the present invention, or first turret;

FIG. 3 is a perspective view of the first turret of FIG. 2;

FIG. 4 is a left side view of a second preferred embodiment of the present invention, or second turret;

FIG. 5 is a schematic of the first turret of FIG. 2 communicatively coupled with a controller, a laser controller, a view selector, and video screen;

FIG. 6 is a schematic of the controller of FIG. 5 communicatively coupled with an electronic comminucatiosn network; and

FIG. 7 is a flow chart of the controller of FIG. 5 in operating the first turret of FIG. 2.

### DETAILED DESCRIPTION OF PREFERRED EMBODIMENTS

In describing the preferred embodiments, certain terminology will be utilized for the sake of clarity. Such terminology is intended to encompass the recited embodiment, as well as all technical equivalents, which operate in a similar manner for a similar purpose to achieve a similar result.

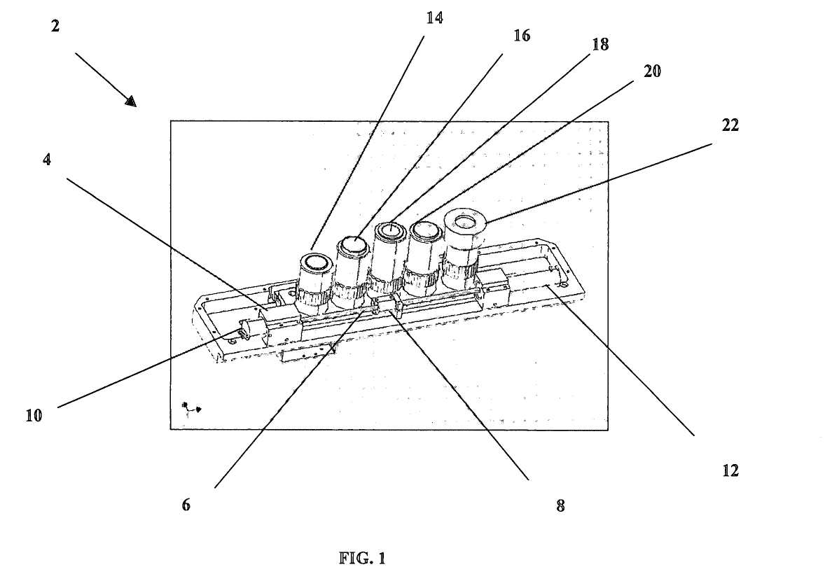

Referring now generally to the Figures and particularly to FIG. 1, FIG. 1 is a view of a prior art linear turret 2 having a cross roller bearing 4, a lead ball screw 6, a pulley 8, a rotary encoder 10 and a rotary motor 12.

The behavior of most prior art rotary turrets will vary drastically upon the magnitude of the weight of the load. If performing with no lens in place, the prior art rotary turret 2 will often undershoot. With a full load (i.e. a plurality of objective lenses 14, 16, 18, 20 & 22), a rotary turret may often overshoot. The repeatability of precise placement of the objectives 14, 16, 18, 20 & 22 is a major concern even if the rotary turret 2 has successfully reached a desired target position. Repeatability is therefore a major problem of prior art designs that include a rotary motor 12 to position an objective 14, 16, 18,20 & 22.

Referring now to the background of the invention and generally to the Figures, prior art rotary turrets 2 are complicated in design and problematic in use. The prior art rotary turrets 2 must simulate the following four functions:

1. Use of two stages of gear reduction with stepper motor (miter gear and worm gear);

2. Use of aluminum bearing races with tungsten carbide balls for turret rotational support;

3. Use of position flag sensors mounted directly to the turret 2 to check repeatability of a positioning system; and

4. Use of a home switch device

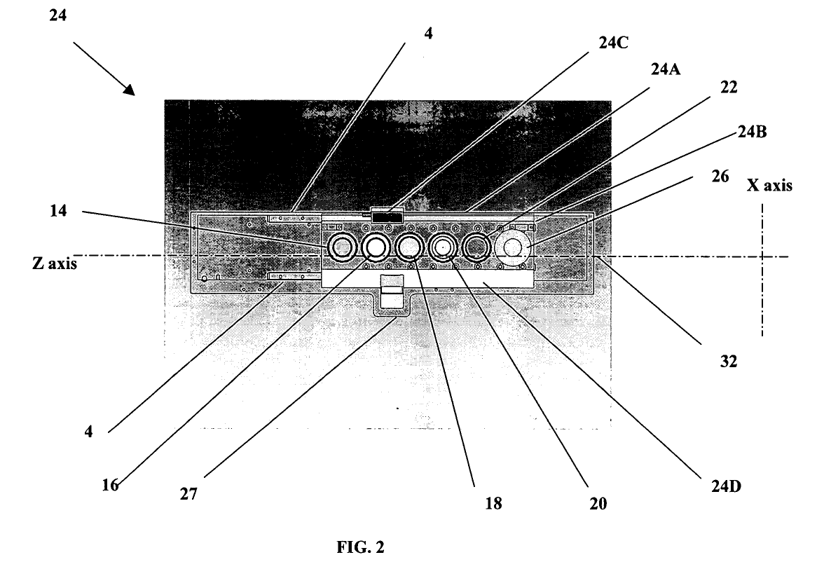

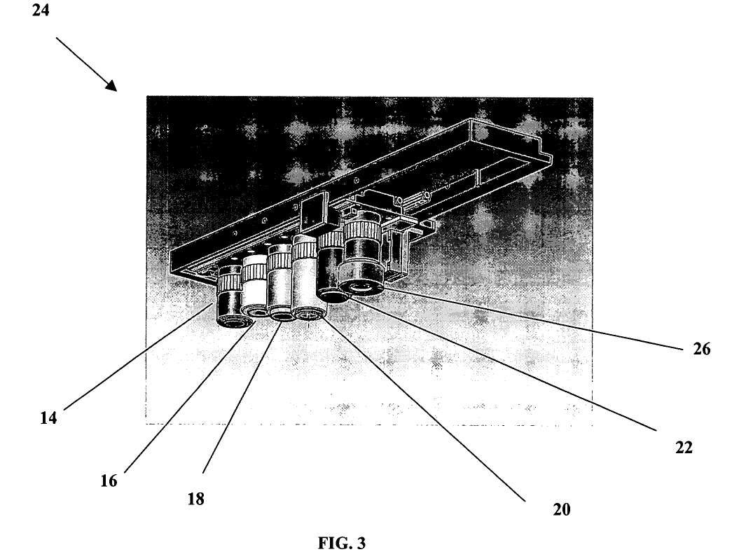

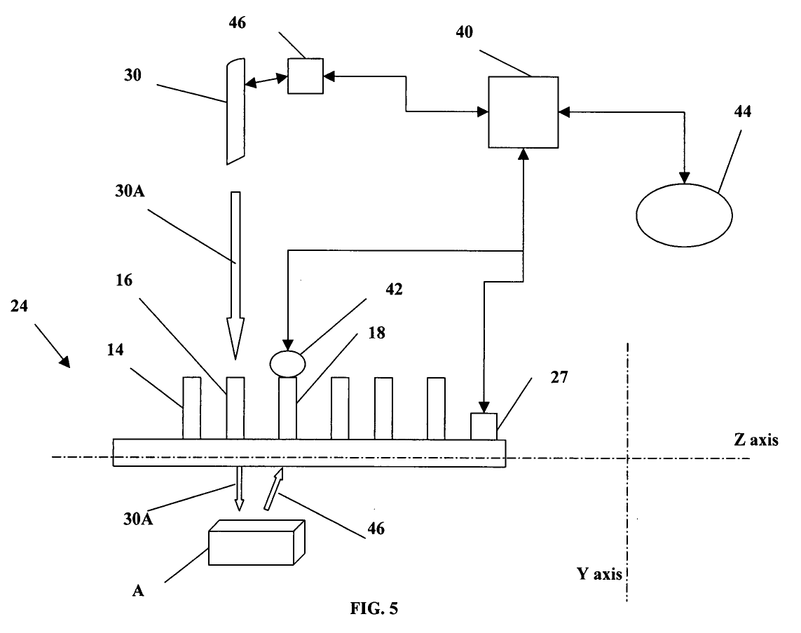

Referring now generally to the Figures and particularly to FIGS. 2 and 3, a first preferred embodiment of the present invention 24 (“first turret”) is an automated linear turret. The six objectives 14, 16, 18, 20, 22 & 26 are located on a carriage plate 28 and are positioned at desired locations or viewpoints, wherein one viewpoint may enable an operator to view an object A or object feature (as per FIG. 5), and another viewpoint may be located to enable application of a laser 30 (as per FIG. 5) to the object A or object feature. A bottom view of the first turret 24 is presented in FIG. 2. The first turret 24 brings one of six objective lenses 14, 16, 18, 20, 22 & 26 into a laser beam path 30A. An operator selects a final image magnification through software menus controlling a standard microscope turret containing a first objective lens 14, 16, 18, 20, 22 & 26. A collimated image of the laser beam aperture passes through a selected objective lens 14, 16, 18, 20, 22 & 26 and performs the appropriate repair function. The operator can then review the effect of each shot of the laser 30 by viewing through a selected objective lens 14, 16, 18, 20, 22 & 26 on the microscope image display on a video monitor 44.

The carriage plate 28 is movabley coupled with a base plate 32, wherein the carriage plate 28 may move along a Z axis but is constrained in movement in two mutually orthogonal axes X and Y. The first turret 26 uses cross-roller bearings 30 mounted on a base plate 32 and to enabling movement of the carriage plate 28, thereby enabling movement by six objective lenses 14, 16, 18, 20, 22 & 26 along a third axis Z and driven by a PCLM (Piezo Ceramics Linear) motor 27 and linear optical encoder feedback. The carriage plate 28 is constrained in movement along a first axis X and a second Y axis. The travel distance permitted to the carriage plate 28 along the third axis Z is enough to handle up to 6 objectives and may be on the order of one centimeter to several meters, wherein each objective may have diameter parallel to the third Z axis that be from less than one millimeter to several centimeters or more.

The first turret includes a scale 24A; a magnet limit sensor 24B on each end of a cross roller bearing 4, an encoder 24C, e.g. a Renshaw encoder model RGH24; a PCLM motor 27, e.g., an SP-8 mode; and a ceramics strip 24D.

The first turret 24 may additionally include or exhibit one or more of the following: (a) a PCLM low profile side-motor design; (b) cool-running—low efficiency; (c) non-contacting increments linear optical encoder; (d) a velocity range up to 250 mm/sec, with acceleration up to 1 g; (e) one or more ceramic finger safety(ies); and/or (f) a cross roller bearing 4 with anti-creep PACT line; and (g) at least one or a plurality of objective lenses 14, 16, 18, 20, 22 & 26 mounted on the carriage plate 28.

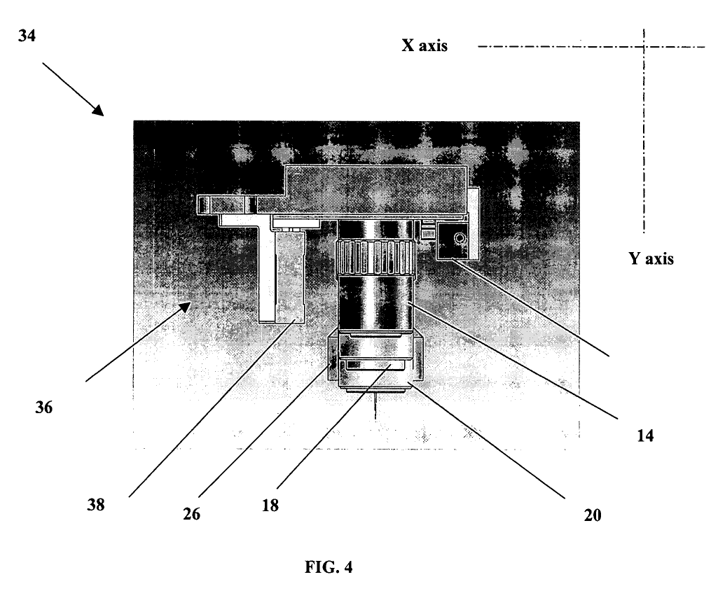

Referring now generally to the Figures and particularly to FIG. 4, an alternate preferred embodiment of the present invention 34 (“second turret 34 ”) comprises a linear a PCLM stage 36 having a PCLM motor 38 that features tool steel cross-roller bearings 4 with an anti-creep PACT line, which partially or totally eliminates bearing cage migration.

In the second turret 34 the PCLM motor 38 and a non-contacting linear encoder 24C are selected for robustness, and require little or no lubrication and reduced effort and frequency of maintenance. The PCLM motor 38 of the second turret 34 may be a self-contained ultrasonic ceramic linear motor that includes an aluminum housing with a series of PZT piezo-transducer elements (“PZT”), wherein the PZT elements actuate a ceramic fingertip against a ceramic strip. As a friction drive embodiment, the PCLM motor 38 is a direct drive with unlimited travel.

An optional amplifier (not shown) of the second turret 34 is designed to drive the PCLM motor 38 in a closed-loop mode. The driver receives a ±10 V analog control input signal from an external command source and translates it into a driving AC voltage for the PCLM motor 38. The external command source can be provided by a servo controller (not shown).

A linear measurement unit of the second turret 34 may be or comprise a high-resolution linear encoder 24C that allows measurement of linear position or speed without contact between a reader head of the linear encoder 24C and the scale 24A. The linear encoder 24C is designed for easy access; quick disconnect features offer high performance and reliable installation. The reader head of the linear encoder 24C provides analog signals that convert to quadrature pulses from which speed, position and direction of travel can be determined. The encoders 24C specify a resolution of 0.1 um for given application. Commercially available prior art non-contact reader heads are easy to install and can be use where speed and position values are sent to a display or use as an input to a controller 40.

Table A explains that certain alternate preferred embodiments of the present invention substantively include or exhibit one or more of the following:

TABLE A

| PCLM Motor | SP-8 |
|---|---|
| Maximum Velocity up to | 200 mm/sec |
| Acceleration up to | 1 g |
| Maximum Force N (lb) | 24.5 (5.5) |
| Resolution (Small Step) Nm | 5 |
| Static Holding Force N (lb) | 40 (10) |
| Drive signal | Pulse AC Sine wave |
| MTBF | 20,000 Hrs |
| Dimension (L × W × H) mm (in) | 42.5 × 36 × 25.5 (1.67 × 1.42 × 1.0) |

Table B contrasts qualities and elements of prior art rotary turrets against qualities and elements of certain alternate preferred embodiments of the present invention.

TABLE B

| | | |
|---|---|---|
| Turrets | Linear | Rotary |
| Objective lens | 6 | 5 |
| Travel | From #1 to #6 | Rotation |
| Accuracy | +/− 2 um | +/− 10 um |
| Repeatability | +/− 1 um | +/− 5 um |
| Encoder resolution | 0.1 um | None |
| Velocity | UP to 200 mm/sec | <3.0 sec from lens to lens |
| Mechanical | Cross-roller bearing | Ball bearing |
| Motor (Nano-Motion) | PCLM motor | Stepper motor |

Certain yet alternate preferred embodiments of the present invention include or exhibit one or more of the following advantages over the prior art:
Continuous or near-continuous position feedback;
Non-contact linear motor whereby mechanical wear is reduced;
Piezo-electricmotor;
Reduction in temperature expansion/contraction;
Less mechanical wear due to lessened mechanical contact of moving parts;
Lower maintenance requirements;
Lessened or eliminated lubrication requirements;
Reduced out-gassing, partly due to reduced volumes of required lubricants;
One or more objective lenses positionable to one or more operating positions or viewpoints; and
A sensor having or being an interferometer and providing nanometer precision of position measurement.

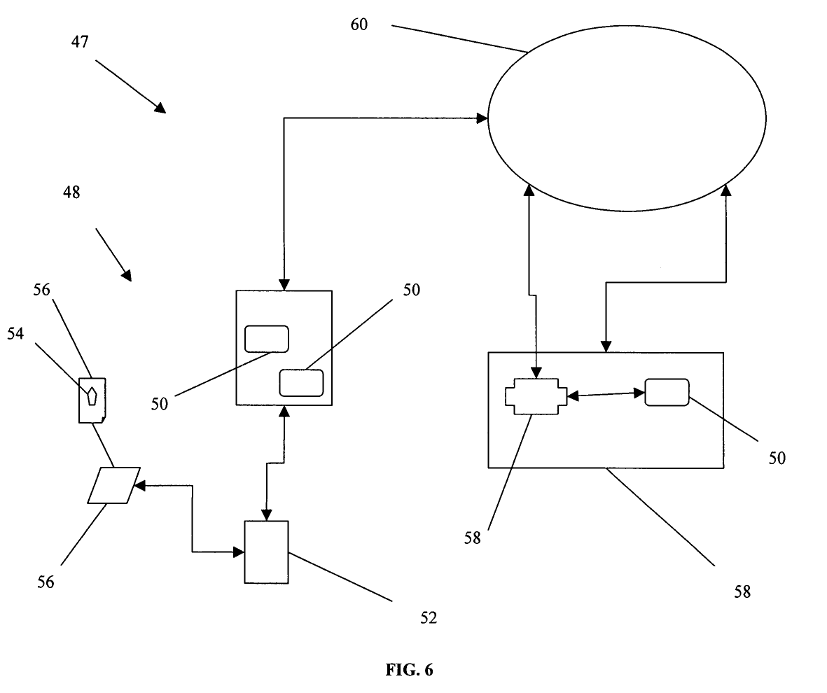

In an exemplary application, the first turret 24 may first position a first objective 14 to allow the operator to visually examine a feature of the object A. The operator might directly view the feature using ambient light and/or light provided by one or more sources. Or the operator might view the object A with the aid of a digital camera 42 and a video display screen 44 (as per FIG. 6) communicatively coupled with the controller 40, by ambient light 46 and/or by light 46 provided by one or more source. The operator might then direct the selected first turret 14, 16, 18, 20, 22 & 26 to position a selected second objective 14, 16, 18, 20, 22 & 26 in relation to the laser 30 to enable the laser 30 to strike the object A after passing through the second selected objective.

Alternatively, certain further alternate embodiments of the method of the present invention may provide a carriage stage 28 that contains at least one objective 14, 16, 16, 20, 22 & 26 and positions one or more objectives 14, 16, 16, 20, 22 & 26 among two or more viewpoints, where each viewpoint may allow visibility of the object A and/or application of the laser 30 or other light energy to the object A.

Referring now generally to the Figures and particularly to FIG. 5, the controller 40 is communicatively coupled with the PCLM motor 27, 38, the digital video screen 44, a laser controller 46, and the camera 44. The controller 40 directs the PCLM motor 27 to position the objective 14, 16, 18, 20, 22 & 26 selected by an operator to orient in relationship to the laser 30 to enable the laser beam 30A to pass through the selected objective 14, 16, 18, 20, 22 & 26 to enable the laser beam 30A to strike the object A as desired by the operator. The controller 40 also directs the digital camera 42 to capture an image of the object A through an objective 14, 16, 18, 20, 22 & 26 selected by the operator. The controller 40 communicates the image data received from the digital camera 42 to the digital video screen 44, wherefrom the operator may view the object A to determine the effect of the laser beam 30A.

Referring now generally to the Figures and particularly to FIG. 6, a third preferred embodiment of the present invention, or third version 47, includes a computer workstation 48 having controller 40, and optionally multiple processors 50, and a media reader 52. Media reader 52 is configured to read software encoded instructions 54 from a computer-readable media 56, and transfer the instructions 54 to one or more processors 50. The software encoded instructions 54 are written in software program 56, and the software program 56 enables and directs one more of the processors 50 to follow the instructions 540 and thereby perform certain still alternate preferred embodiments of the Method of the Present Invention. The workstation 8 is communicatively coupled with the first turret 24 of FIGS. 2 and 3, and directs the operations of the first turret 2 in accordance with the instructions 54. The workstation 48 may additionally be coupled with the optical system 58, and/or the optical system 58 may be communicatively coupled with the first turret 24, whereby the workstation 48 and/or the optical system 58 may alternatively, optionally or additionally control and direct the first turret 24 to operate either in synergy with or service to the optical system 58 and/or the workstation 48.

The communications network 60 is communicatively coupled with the workstation 48, the first turret 24, and the optical system 58 and may provide instructions to the workstation 48, the first turret 24 and/or the optical system 58 to perform certain still alternate preferred embodiments of the Method of the Present Invention.

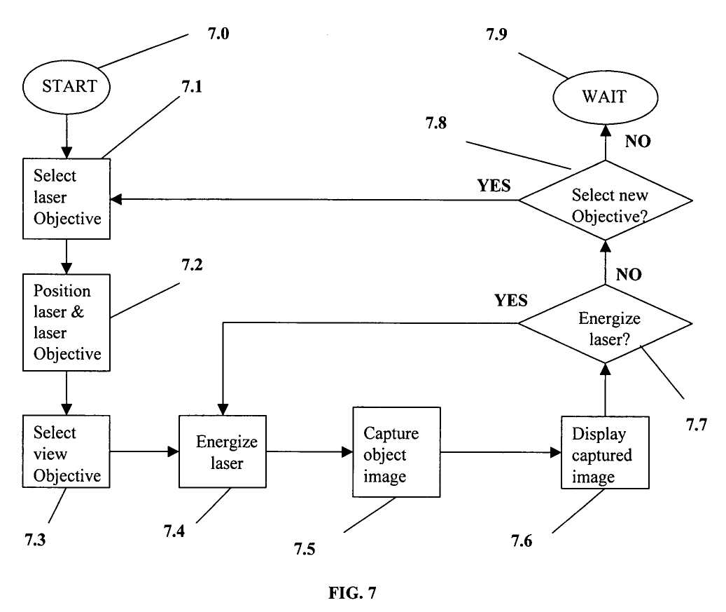

Referring now generally to the Figures and particularly to FIGS. 2, 5, and 7, FIG. 7 is a flowchart of a software program that may be executed by the first turret 24 of FIG. 2. In step 7.0 the first turret 24, the laser 30 and the laser controller 46, the digital camera 42 and the digital video screen 44 are powered up. In step 7.1 a software program or a human operator to selects an objective 14, 16, 18, 20, 22 & 26 for delivering the laser beam 30A to the object A. In step 7.2 the controller 40 directs the laser controller 46 and the PCLM 27 to position the laser and the objective 14, 16, 18, 20, 22 & 26 to focus the laser beam 30A to the object A. In step 7.3 a human operator or software program selects and the controller 40 positions (by means of the PCLM 27 and the carriage stage 28) the objective 14, 16, 18, 20, 22 & 26 through which the operator may view the object A by means of the digital camera 42 and the digital video screen 44. In step 7.4 the controller 40 directs the laser controller 46 to energize the laser 30 and the laser 30 is energized. In step 7.5 the digital camera 42 captures an image of the object A and in step 7.6 the digitized image is delivered to the digital video screen 44 and the image captured by the camera 42 is visually presented on the digital video screen 44. In step 7.7 the controller determines whether to continue to strike, or strike again, the object A with the laser beam 30A. If the controller determines to continue or repeat striking the object A with the laser beam 30, the controller proceeds from step 7.7 to execute step 7.4.

If the controller determines discontinue continue or not repeat striking the object A with the laser beam 30, the controller proceeds from step 7.7 to execute step 7.8. In step 7.8 the controller determines whether to select another objective through which to view the object A and/or to deliver the laser beam 30A to the object A. If the controller determines to select an alternate objective 14, 16, 18, 20, 22 & 26, the controller proceeds from step 7.8 to execute step 7.1. If the controller determines to not select an alternate objective 14, 16, 18, 20, 22 & 26, the controller proceeds from step 7.8 to execute step 7.9 to wait for further direction.

Those skilled in the art will appreciate that various adaptations and modifications of the just-described preferred embodiments can be configured without departing from the scope and spirit of the invention. Other suitable fabrication, manufacturing, assembly, and test techniques and methods known in the art can be applied in numerous specific modalities by one skilled in the art and in light of the description of the present invention described herein. Therefore, it is to be understood that the invention may be practiced other than as specifically described herein. The above description is intended to be illustrative, and not restrictive. Many other embodiments will be apparent to those of skill in the art upon reviewing the above description. The scope of the invention should, therefore, be determined with reference to the knowledge of one skilled in the art and in light of the disclosures presented above.

We claim:

1. An optical turret for positioning at least one objective relative to a light energy source, the optical turret communicatively coupled with a processor, the optical turret comprising:
at least one objective;
a carriage plate, the carriage plate configured with a first objective aperture, and the at least one objective coupled with the first objective aperture;
a linear rail, the linear rail substantively limiting movement of the carriage plate along two orthogonal linear axes and enabling linear movement along a third linear axis;
a scale, the scale coupled to the optical turret and the scale having a plurality of linear distance indicators;
a sensor, the sensor coupled with the optical turret, and the sensor positioned for detecting at least one of the linear distance indicators, and the sensor communicatively coupled with the processor, and
a linear motor, the linear motor for adjustable positioning of the carriage plate, the linear motor coupled with the carriage plate, and the linear motor communicatively coupled with and directed by the processor.

2. The optical turret of claim 1, wherein the linear motor comprises a non contact linear motor and the carriage plate is configured to move under the influence of the non contact linear motor.

3. The optical turret of claim 2, wherein the non contact linear motor is a magnetic system and the carriage plate is configured to move under the influence of a magnetic force generated by the magnetic system.

4. The optical turret of claim 1, wherein the linear motor comprises piezo-electric fingers, the piezo-electric fingers mechanically coupled with the carriage plate, and the piezo-electric fingers are positioned to physically drive the carriage plate by transferring mechanical momentum to the carriage plate to move the carriage plate substantively along the third linear axis

5. The optical turret of claim 4, wherein the linear motor is a ceramic motor.

6. The optical turret of claim 5, wherein the ceramic motor is an ultrasonic ceramic linear motor.

7. The optical turret of claim 1, wherein the carriage plate further comprises a cross roller bearing, the cross roller bearing positioned to facilitate movement of the carriage plate in contact with the linear rail.

8. The optical turret of claim 7, wherein the cross roller bearing comprises a low vapor pressure lubricant.

9. The optical turret of claim 1, wherein the sensor is coupled with the carriage plate and the scale is coupled with the linear rail.

10. The optical turret of claim 1, wherein the optical turret further comprises a linear encoder, the linear encoder communicatively coupled with the processor and the sensor.

11. The optical turret of claim 10 wherein the sensor and the linear encoder are coupled with the carriage plate and the scale is coupled with the linear rail.

12. The optical turret claim 1 wherein the sensor comprises an interferometer.

13. The optical turret of claim 1, wherein the optical turret further comprises:
a second objective aperture of the carriage plate; and
a second objective, the second objective coupled with the second objective aperture, whereby the at least one objective and the second objective are simultaneously positioned along the third axis.

14. An optical turret for positioning at least one objective relative to a light energy source, the optical turret communicatively coupled with a processor, the optical turret comprising:
at least one objective;
a means to substantively constrain movement of the at least one objective along two orthogonal axis, wherein linear movement substantively along a third axis is enabled;
a scale, the scale coupled with the optical turret having a plurality of linear distance indicators located along the selected axis;
a sensor, the sensor coupled with the optical turret, and the sensor for detecting at least one of the linear distance indicators, and the sensor communicatively coupled with the processor, and
a linear motor, the linear motor for adjustable positioning of the carriage plate, the linear motor coupled with the carriage plate, and the linear motor communicatively coupled with and directed by the processor.

15. The optical turret of claim 14, wherein the linear motor wherein the linear motor is a magnetic system and the carriage plate is configured to move under the influence of a magnetic force generated by the magnetic system.

16. The optical turret of claim 14, wherein the linear motor comprises piezo-electric fingers, the piezo-electric fingers mechanically coupled with the carriage plate, and the piezo-electric fingers are positioned to physically drive the carriage-plate by transferring mechanical momentum to the carriage plate to move the carriage plate substantively along the third linear axis

17. The optical turret of claim 1, wherein the optical turret further comprises:
a second objective aperture of the carriage plate; and
a second objective, the second objective coupled with the second objective aperture, whereby the at least one objective and the second objective are simultaneously positioned along the third axis.

18. A method of positioning at least one objective relative to a light energy source, the method comprising:
coupling the at least one objective to a carriage stage;
enabling movement of the carriage stage by a linear motor;
enabling control of the linear motor by a processor;
providing information to the processor describing the approximate position of the carriage relative to the light energy source; and
directing the processor to position the at least one objective to a specific approximate orientation of the at least one objective.

19. The method of claim 18, wherein the linear motor is a non-contact linear motor.

20. The method of claim 18, wherein the linear motor is a piezo-electric motor.
